(19) United States
(12) Patent Application Publication
(10) Pub. No.: US 2020/0130866 A1
(43) Pub. Date: Apr. 30, 2020

(54) STRUCTURAL USAGE MONITORING SYSTEM AND METHOD

(71) Applicant: HONEYWELL INTERNATIONAL INC., Morris Plains, NJ (US)

(72) Inventor: Ramaprasad Srinivasan, Bangalore (IN)

(73) Assignee: HONEYWELL INTERNATIONAL INC., Morris Plains, NJ (US)

(21) Appl. No.: 16/173,347

(22) Filed: Oct. 29, 2018

(51) Int. Cl. B64F 5/60; G07C 5/08; G05B 23/02; G06F 15/18; B64D 45/00

(52) U.S. Cl. CPC B64F 5/60; G07C 5/0841; B64D 2045/0085; G06F 15/18; B64D 45/00; G05B 23/0235

(57) ABSTRACT

A method for monitoring service load on airborne vehicle components is provided. The method includes: extracting, from an airborne vehicle after completing a mission, the start and end time of each of a plurality of flight regimes and flight parameters of interest for each of the plurality of flight regimes; generating, for each regime, a time domain spectrum of the stress spectrum for each regime/events/maneuvers actually encountered in the mission from the extracted flight parameters; determining flight conditions experienced during the planned mission; determining a stress per G spectrum corresponding to the experienced flight conditions, wherein the stress per G spectrum identifies an amount of stress experienced by the airborne vehicle at fatigue critical locations per G of air load experienced at the fatigue critical locations; and determining an air load stress spectrum for the airborne vehicle by multiplying the time domain spectrum data with corresponding stress per G spectrum data.

### TECHNICAL FIELD

The technology described in this patent document relates generally to health monitoring systems and methods for airborne vehicles and more particularly to structural usage monitoring systems and methods in airborne vehicles.

### BACKGROUND

Fatigue failure is a predominant airframe failure mode in both helicopters and aircrafts. Helicopter components that experience fatigue failure include gearboxes, engines, transmissions, airframe (fuselages) undercarriage, and others. Aircraft components that experience fatigue failure include the airframe, landing gear, engines and undercarriages. Most of the helicopter components and the landing gear on aircraft are designed based on a safe life design concept, which requires replacement of a part once its design life is consumed or a crack has begun, whichever is earlier. Most of the airframe structure on aircraft are designed based on a damage tolerant philosophy, which requires regular inspection at periodic intervals to detect operational fatigue damage.

Currently inspection thresholds and repeat intervals are established by using a conservative load spectrum for estimating design fatigue life, which does not account for the actual operational usage. The actual load experience encountered by a specific aircraft may deviate appreciably from these design assumptions. If an airline operator could demonstrate that the load experience of its aircraft is less severe than the design assumption, it might be able to request the airworthiness authority to adjust replacement times and inspection intervals. On the other hand, if the load experience is more severe, it would be beneficial to shorten inspection intervals from safety considerations.

Hence, it is desirable to provide systems and methods for monitoring actual service load experience. Furthermore, other desirable features and characteristics of the present disclosure will become apparent from the subsequent detailed description and the appended claims, taken in conjunction with the accompanying drawings and the foregoing technical field and background.

### SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method for monitoring service load on airborne vehicle components is provided. The method includes: extracting, from an airborne vehicle after completing a planned mission, the start and end time of each of a plurality of flight regimes, flight events, and maneuvers (regimes/events/maneuvers) and flight parameters of interest for each of the plurality of regimes/events/maneuvers; generating, for each regime/events/maneuvers, a time domain spectrum of the stress spectrum for each regime/events/maneuvers actually encountered in the mission from the extracted flight parameters of interest; determining flight conditions experienced during the planned mission from the time domain spectrum data for each flight parameter of interest; determining a stress per G (e.g., per unit load) spectrum corresponding to the actually experienced flight conditions, wherein the stress per G spectrum identifies an amount of stress experienced by the airborne vehicle at identified fatigue critical locations per G of air load caused by the regimes/events/maneuvers experienced in the planned mission at the fatigue critical location of interest; and determining a total air load stress spectrum for the airborne vehicle from the performance of the planned mission by multiplying the time domain spectrum data for each flight parameter of interest with corresponding stress per G spectrum data determined for the experienced flight conditions and summing up the air load stress spectrum obtained for all regimes/event/maneuvers encountered during the mission.

A structural usage monitoring system is provided. The structural usage monitoring system includes one or more processors configured by programming instructions in non-transient computer readable media. The structural usage monitoring system is configured to: identify, based on a mission profile for a planned mission for an airborne vehicle, flight parameters of interest for each of a plurality of different flight regimes/events/maneuvers within a planned mission; instruct the airborne vehicle to record, during performance by the airborne vehicle of the planned mission, the start and end time of each of the plurality of flight regimes/events/maneuvers and the flight parameters of interest for each of the plurality of regimes/events/maneuvers; extract, from the airborne vehicle after completing the planned mission, the start and end time of each of the plurality of regimes/events/maneuvers and the flight parameters of interest for each of the plurality of regimes/events/maneuvers; and generate for each regime, from the recorded aircraft parameters, a time domain spectrum of the stress spectrum for each regime/events/maneuvers actually encountered in the mission from the extracted flight parameters of interest. The structural usage monitoring system is further configured to: determine flight conditions experienced during the planned mission from the time domain spectrum data; determine a stress per G (e.g., per unit load) spectrum corresponding to the determined flight conditions, wherein the stress per G spectrum identifies an amount of stress experienced by the airborne vehicle at fatigue critical locations per G of air load caused by the regimes/events/maneuvers experienced in the planned mission at the fatigue critical location of interest; determine a total air load stress spectrum for the airborne vehicle from the performance of the planned mission by multiplying the time domain spectrum data for each flight parameter of interest with corresponding stress per G spectrum data determined for the experienced flight conditions and summing up the air load stress spectrum obtained for all regimes/event/maneuvers encountered during the mission; and compute a damage index for the airborne vehicle from the total air load stress spectrum using a cycle counting method for each identified fatigue critical location for the planned mission.

A remaining useful life module in a structural usage monitoring system is provided. The structural usage monitoring system includes one or more processors configured by programming instructions on non-transient computer readable media. The structural usage monitoring system is configured to extract flight parameters of interest from an airborne vehicle for a plurality of flight regimes/events/maneuvers from a mission and determine a total air load stress spectrum for the airborne vehicle using the extracted flight parameters and a stress per G (e.g., per unit load) spectrum wherein the stress per G spectrum identifies an amount of stress experienced by the airborne vehicle at fatigue critical locations per G of air load caused by the regimes/events/maneuvers at the fatigue critical locations. The remaining useful life module is configured to: estimate the remaining useful life of a component at a fatigue critical location based on the most likely flight profile to be experienced at the fatigue critical location on future flights; estimate the remaining useful life by deriving a likely mission profile for the remaining missions to be performed based on past missions performed; perform a what if analysis to assess the likely impact that changing the mission profile for future missions would have on damage accumulation; and generate a usage-based maintenance plan specific to a specific airborne vehicle based on the usage pattern of the specific airborne vehicle thereby facilitating Individual Aircraft Tracking (IAT) by calculating the inspection thresholds and repeat intervals for different fatigue critical locations and developing a strategy to escalate or deescalate inspection plans which is reflected in a CBM advisory report.

Furthermore, other desirable features and characteristics will become apparent from the subsequent detailed description and the appended claims, taken in conjunction with the accompanying drawings and the preceding background.

### BRIEF DESCRIPTION OF THE DRAWINGS

Aspects of the present disclosure are best understood from the following detailed description when read with the accompanying figures, wherein like numerals denote like elements, and

FIG. 1 is a block diagram depicting an example operating environment in which a structural usage monitoring system (SUMS) may be employed, in accordance with some embodiments;

FIG. 2 is a block diagram depicting an example SUMS, in accordance with some embodiments;

FIG. 3 is process flow chart depicting an example process in a SUMS, in accordance with some embodiments; and

FIG. 4 is a process flow chart depicting another example process in a SUMS, in accordance with some embodiments.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, summary, or the following detailed description. As used herein, the words “exemplary” or “example” means “serving as an example, instance, or illustration.” Thus, any embodiment described herein as “exemplary” or “example” is not necessarily to be construed as preferred or advantageous over other embodiments. All embodiments described herein are exemplary embodiments provided to enable persons skilled in the art to make or use the invention and not to limit the scope of the invention which is defined by the claims.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques and articles for monitoring flight load parameters using a QAR (quick access recorder) or FDR (flight data recorder) or any other equivalent data acquisition system as may be relevant and performing flight load synthesis using simulation models. The subject matter described herein can be implemented as a ground based solution that can be performed after every mission to provide real time assessment of fatigue at OEM (original equipment manufacturer) chosen fatigue critical locations and also provide a flexibility for the operator to define any other location driven by field considerations for which fatigue usage needs to be tracked. The described apparatus, systems, techniques and articles can make it possible for maintenance operators to facilitate individual aircraft tracking. The described apparatus, systems, techniques and articles can allow for threshold, inspection intervals or repeat intervals to be calculated for each individual aircraft tail purely based on the fatigue usage expressed in terms of damage index of the component. The described apparatus, systems, techniques and articles could be deployed by an aircraft or a helicopter operator through a web based interface and several analytic solutions can be provided to provide lasting value for reducing maintenance and operating cost as well as minimizing unscheduled inspections.

In one example, a methodology that can be used to track the usage (e.g., capture the stress reversal) pattern at all fatigue critical locations usually identified by the OEM and provided to the operator is given. Each fatigue critical location can be identified by its explicit coordinate location in the aircraft coordinate system or more specifically as a node in the finite element model having its nodal coordinates modelled in the aircraft coordinate system. Driven by field issues, an operator may also want to track the fatigue damage at zones other than at OEM defined locations. Those zones may not be explicitly identified by a node in the finite element model, and to track the fatigue damage at those zones the transfer function for the stress/G at the new locations will need to be established, for example, by interpolation from nearby locations, using soft computing tools (e.g., artificial neural networks), or other methods such as regression and others. The example methodology provides for the development of a data analytic platform to predict the transfer function for all the simulated flight conditions even in case of a need for the operator to include an additional location for tracking fatigue usage driven by considerations of field issues.

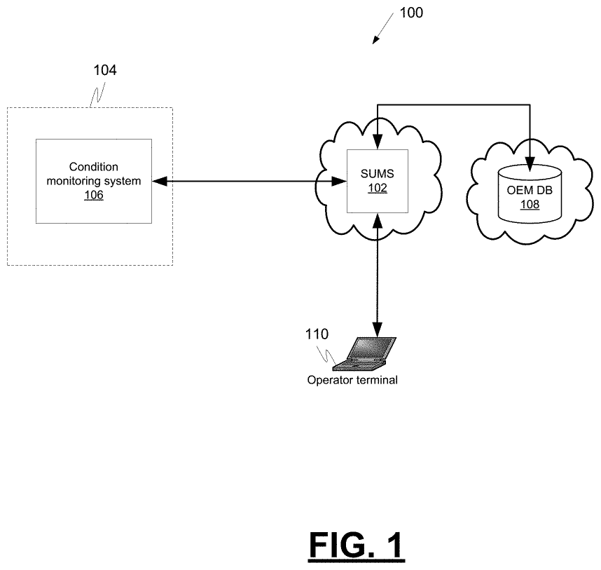

FIG. 1 is a block diagram depicting an example operating environment 100 in which a structural usage monitoring system (SUMS) 102 may be employed. The example SUMS 102 is configured to retrieve flight parameters generated by an airborne vehicle 104 (commercial or military), such as an aircraft or helicopter, while performing missions and based on the flight parameters predict the air load experienced at various structural points throughout the life of the airborne vehicle. The example SUMS 102 is further configured to predict the stress experienced at the structural points throughout the life of the airborne vehicle and predict the damage caused by the cumulative stress experienced at the structural points. The example SUMS 102 is also configured to predict the remaining useful life of airborne vehicle structural components at the structural points, for example, by considering the most likely mission profile to be experienced by the aircraft or helicopter for its future missions assessed purely by data driven insights out of analyzing past historical data.

The example operating environment 100 includes an airborne vehicle 104 having a structural condition monitoring system 106 with which the example SUMS 102 interacts. The example structural condition monitoring system 106 is configurable to record a variety of flight parameters, during flight of the airborne vehicle, such as: Normal Acceleration, Lateral Acceleration, Longitudinal Acceleration, Roll, Pitch, Yaw, Roll rate, Pitch Rate, Yaw Rate, Roll Acceleration, Pitch Acceleration, Altitude, Temperature, Pressure, Angle of Attack, Side Slip Angle, Mass of Fuel, Mach Number, and Calibrated Air Speed. The example condition monitoring system 106 is configurable to record the flight parameters using on-board recording systems such as a flight data recorder (FDR) or quick access recorder (QAR) or any other equivalent data acquisition system. The example structural condition monitoring system 106 is configurable to record specific, pre-determined flight parameters after certain pre-determined flight conditions have occurred, such as the airborne vehicle entering a specific flight regime or performing a specific maneuver. All flight conditions, flight regimes/events/maneuvers that contribute to fatigue usage at any location should be included for tracking or recording. A flight regime may be a phase of flight in which the airborne vehicle travels within a specific flight speed range. For example, a subsonic flight regime may occur when an airborne vehicle travels at a speed between about 350-750 MPH (e.g., <Mach 1); a transonic regime may occur when an airborne vehicle travels at a speed around Mach 1; a supersonic regime may occur when an airborne vehicle travels at a speed between about 760-3500 MPH (e.g., Mach 1-Mach 5); and a hypersonic regime may occur when an airborne vehicle travels at a speed between about (3500-7000 MPH (e.g., Mach 5 to Mach 10).

The example operating environment 100 also includes an OEM database 108 from which the example SUMS 102 may access information that identifies fatigue critical locations on OEM components at which to monitor for stress and/or damage. The OEM database 108 may also include estimated stress per G (e.g., stress/G) values that have been calculated by the OEM for the fatigue critical locations based on component test data or based on simulation models like the finite element models of the aircraft or the helicopter. The estimated stress/G values may identify expected levels of stress to be experienced by an airborne vehicle at the fatigue critical locations per G of air load caused at the location due to an aircraft performing a certain flight regime, flight event or flight maneuver. The example SUMS 102 may access the fatigue critical location information to extract the stress/G from the simulation DB for all the plurality of regimes/events/maneuvers experienced by the aircraft on the airborne vehicle 104 on which to compute for stress and may access the estimated stress/G values to generate a stress/G model that can be used to estimate cumulative stress experienced on the airborne vehicle 104 at the fatigue critical locations. In this example, the simulation OEM DB has information on the stress experienced at all fatigue critical locations per G of load caused by the parameters responsible for a particular regime/events/maneuvers corresponding to a subset of total flight operational scenarios. Also, in this example, the simulation OEM DB includes simulation data like stresses corresponding to mutually inclusive set of all flight regimes/events/maneuvers performed by the aircraft on a multitude of missions it has undertaken or will undertake based on its designed intent.

The example operating environment 100 further includes an operator terminal 110, which may be used by an airborne vehicle operator to initiate and/or retrieve cumulative stress and/or damage estimates. Through the example operator terminal 110, a user may access the SUMS 102 to initiate and/or retrieve cumulative stress and/or damage estimates.

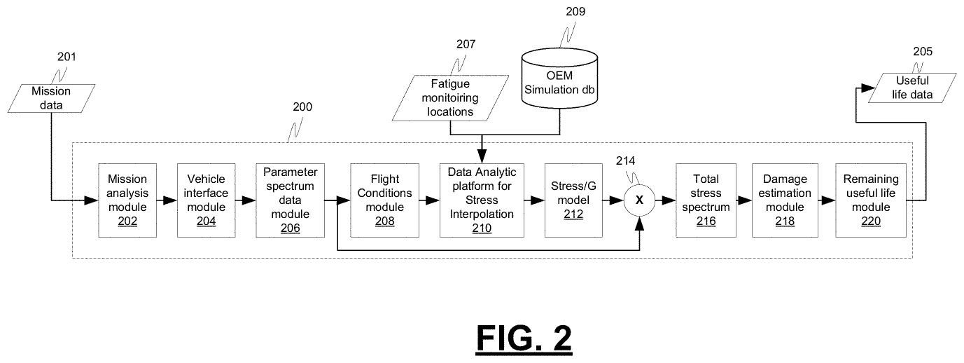

FIG. 2 is a block diagram depicting an example SUMS 200. The example SUMS 200 is configured to receive proposed mission data 201, analyze the proposed mission data 201 to determine all regimes/events/maneuvers and corresponding airborne vehicle parameters for recording during performance of a mission corresponding to each flight regimes/events/maneuvers, instruct the airborne vehicle to record all relevant parameters at a certain sampling frequency, retrieve the recorded parameters after performance of the mission, estimate from the retrieved parameters the stress experienced by the airborne vehicle during performance of the mission corresponding to the plurality of all regimes/events/maneuvers, generate air load stress data 216 for the mission by summing the individual stress spectrum of the plurality of all regimes/events/maneuvers for various critical fatigue locations on the airborne vehicle that indicate the estimated stress spectrum experienced at those locations during the mission, estimate damage experienced at those locations due to cumulative stress spectrum experienced at those locations from current and previous missions, and estimate remaining useful life 205 of components at those locations based on cumulative stress spectrum and expected stress spectrum to be experienced based on past historical mission profiles using mission templates. The example SUMS 200 includes a mission analysis module 202, a vehicle interface module 204, a flight parameter spectrum data module 206, a flight conditions module 208, a data analytic platform for stress interpolation module 210, a stress per G model 212, a stress calculation module 214, a damage estimation module 218, and a remaining useful life module 220. The example SUMS 200 and its included modules are implemented by a controller.

The example controller includes at least one processor and a computer-readable storage device or media. The processor may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller. The instructions may include one or more separate programs, each of which comprises an ordered listing of executable instructions for implementing logical functions. The instructions, when executed by the processor, receive and process signals, perform logic, calculations, methods and/or algorithms for controlling the SUMS 200.

The example mission analysis module 202 is configured to identify, based on a mission profile in mission data 201 for a planned mission for an airborne vehicle, flight parameters of interest for each of a plurality of different flight regimes within the planned mission. The example mission analysis module 202 is configured to identify the plurality of regimes/events/maneuvers from the mission profile by identifying a plurality of flight phases and all possible flight events/maneuvers likely to occur within each flight phase from the mission profile and identifying the plurality of flight regimes/events/maneuvers from the plurality of flight phases.

The mission profile, among other things, identifies the different flight phases in the mission and also the different flight regimes/events/maneuvers flight phase wise likely to be encountered. For commercial transport, as an example, each flight can be divided into nine phases—four ground phases (taxi out, takeoff roll, landing roll with and without thrust reverser, and taxi in) and five airborne phases (departure, climb, cruise, descent, and approach). These nine phases of a typical commercial flight are listed in Table 1 below. Similar considerations for a military aircraft or a military helicopter shall involve different phases based on the intended mission of the platform and correspondingly different regimes/events/maneuvers shall be applicable for them. This disclosure shall cover the plurality of all intended mission profiles and its associated regimes/events/maneuvers.

TABLE 1

| Flight Phase | Conditions for Determining Start of Phase |
|---|---|
| Taxi Out | Initial aircraft movement |
| Takeoff Roll | Acceleration greater than 2 kts/sec. for a |
| | minimum of 20 seconds |
| Landing Roll | Touchdown |
| Taxi In | Magnetic heading change greater than 13.5 |
| | degrees after touchdown |
| Departure | Time at liftoff; flaps extended |
| Climb | Flaps retracted; rate of climb greater than or equal |
| | to 250 ft/min for at least 1 minute |
| Cruise | Flaps retracted; rate of climb less than or equal to |
| | 250 ft/min for at least 1 minute |
| Descent | Flaps retracted; rate of descent greater than or equal |
| | to 250 ft/min for at least 1 minute |
| Approach | Flaps extended; rate of descent greater than or equal |
| | to 250 ft/min for at least 1 minute |

Table 1 also provides an example listing of conditions for determining the starting times for each flight phase. The conditions can change from aircraft to aircraft. Also, a flight phase can occur several times per flight because a number of phases are determined by the rate of climb and the position of the flaps. When a flight phase occurs multiple times during a mission, flight load data for each occurrence of the flight phase can be individually processed, time stamped and accumulated with the data for all occurrences of the flight phase. Because the data is time stamped, the different occurrences of the phase will be apparent. This can help in deriving insights on operational issues driving fatigue damage while performing fleet analytics.

Flight regimes can be determined based on the airspeed and altitude of the airborne vehicle and possibly few other flight parameters of interest as may be applicable in each case. Different regimes can be identified based on the type of aircraft (commercial or military) or helicopter concerned and the end user objectives for which they are designed.

In each regime, a plurality of maneuvers or flight events may occur that contribute to the air load experienced by the airborne vehicle. Potential maneuvers and/or flight events are listed below in Table 2:

TABLE 2

| | | |
|---|---|---|
| Flaps up | Landing | Right Sideslip in Climb |
| Flaps Down | IGE Hover less than 80 feet | Left Climbing Turn |
| Turn in Air | OGE Hover greater than 80 feet | Right Climbing Turn |
| Bank | Fwd Flight to 0.3 Vh | Approach |
| Roll up | Right Sideward Flight | Rough Approach |
| Roll down | Left Sideward Flight | Rudder Reversal in Level Flight to 1.0 Vh |
| Taxi in | Rearward Flight | Lateral Reversal in Level Flight to 1.0 Vh |
| Taxi out | Rudder Reversal in Level Flight | Longitudinal Reversal in Level Flight to 1.0 Vh |
| Take-off | Lateral Reversal in Level Flight | Partial Power Descent |
| Climb | Longitudinal Reversal in Level Flight | Rudder Reversal in Partial Power Descent |
| Descent; | Left Sideslip in Level Flight | Longitudinal Reversal in Partial Power Descent |
| Wind up turn | Right Sideslip in Level Flight | Lateral Reversal in Partial Power Descent |
| Roller coaster | Best Rate of Climb | Dive |
| Elevator up | Intermediate Power Climb | Rudder Reversal in Dive |
| Elevator down | Takeoff Power Climb | Longitudinal Reversal in Dive |
| Left Turn in Taxi | Left Sideslip in Climb | Lateral Reversal in Dive |
| Right Turn in Taxi | | |

The air load experienced by the airborne vehicle during a maneuver or flight event can be derived from flight parameters that are determined during the maneuver or flight event. The flight parameters that influence different maneuvers or flight events may include those listed below in Table 3 and others. The example mission analysis module 202 is configured to identify a plurality of flight parameters of interest for each flight regime based on expected flight events/maneuvers to be performed during the flight regime, wherein the flight parameters of interest associated with some of the regimes are different from flight parameters of interest associated with other regimes, and wherein the flight parameters of interest can be used for capturing an air load spectrum.

TABLE 3

| | | | |
|---|---|---|---|
| Normal | Yaw | Pitch Acceleration | Side Slip Angle |
| Acceleration | | | |
| Lateral | Roll rate | Altitude | Mass of Fuel |
| Acceleration | | | |
| Longitudinal | Pitch Rate | Temperature | Mach Number |
| Acceleration | | | |
| Roll | Yaw Rate | Pressure | Calibrated Air Speed |
| Pitch | Roll Acceleration | Angle of Attack | |

The example vehicle interface module 204 is configured to instruct the airborne vehicle to record, during performance by the airborne vehicle of the planned mission, the start and end time of each of the plurality of flight regimes/events/maneuvers and the flight parameters of interest for each of the plurality of flight regimes/events/maneuvers. Flight phase recognition algorithms, regime recognition algorithms, flight event recognition algorithms and/or maneuver identification algorithms may be employed to allow the airborne vehicle to recognize the start and ending of flight regimes/events/maneuvers and allow the airborne vehicle to record starting and ending times for flight regimes/events/maneuvers.

The example vehicle interface module 204 is further configured to extract, from the airborne vehicle after completion of the mission, the starting times, ending times, and the time domain spectrum of the flight parameters of interest (e.g., parameter spectrum) for the flight regimes/events/maneuvers. The flight parameters may be recorded on and extracted from a QAR or FDR or potentially any other data acquisition unit like CPL (cumulative parametric logging) deployed in the Boeing 787 aircraft. Alternatively, if an aircraft is equipped with an aircraft conditioning monitoring system, the flight event/maneuver identification logic can be incorporated into the onboard embedded software to record the flight parameters of interest as and when the event occurred based on the identification algorithms implemented. Event reports are generated and could be downloaded on the completion of the aircraft/helicopter's mission. These reports can be then post processed further on the ground to derive the air load stress spectrum required for computing the damage index and the remaining useful life.

The example flight parameter spectrum data module 206 is configured to generate for each regime, from the extracted aircraft parameters, a time domain spectrum of the stress spectrum for each regime/events/maneuvers actually encountered in the mission (e.g., parameter spectrum). The generated time domain spectrum for a flight parameter can be generated for a particular flight phase, for different altitudes, Mach number, and angle of attack combinations.

The example flight conditions module 208 is configured to determine flight conditions experienced during the mission and also to identify all the flight events and maneuvers that occurred during the planned mission from the time domain spectrum data. The flight conditions may include the airborne vehicle Mach number, flight phase, and airborne vehicle altitude. In other examples, the flight conditions may include additional data, such as angle of attack, fuel weight or takeoff weight, in addition to Mach number, flight phase, and airborne vehicle altitude.

The simulation models available from the OEM DB 209 should have stress models for certain flight operational situations and most likely may not have the stress models for the actual flight condition encountered by the aircraft/helicopter. The OEM DB 209 should have simulation models for the potential regimes/events/maneuvers corresponding to different flight phases as applicable for the mission for which the aircraft/helicopter are designed. The example data analytic platform for stress interpolation module 210 is configured with stress interpolation algorithms, such as those implementing regression and soft computing tools (e.g., artificial neural networks), which given a set of simulated flight condition from the OEM DB 209 can calculate and yield the stress/G at all fatigue critical locations for encountered flight conditions.

The simulation data 209 by the OEM most likely will not include data related to a multitude of flight conditions experienced by the aircraft. Hence the data analytic platform for stress interpolation module 210 is provided to interpolate the stress per G calculation from the simulated flight conditions to the flight conditions actually experienced by the aircraft. The example data analytic platform for stress interpolation module 210 is configured to perform the interpolation using one or more methods such as regression, parameter estimation, or soft computing tools (e.g., artificial neural networks).

Using flight testing data, wind tunnel models or finite element simulation models, an OEM may generate a database 209 of stress per G simulation data at various test speeds and altitudes (corresponding to a multitude of flight conditions) at design evolved fatigue critical locations 207. The simulation DB 209 should include the stress per G calculation for all mutually inclusive sets of regimes/maneuvers/events (during each of the flight phases identified by the mission profile) likely to be experienced by the aircraft to allow the simulation data to match actually experienced flight conditions as accurately as possible.

The example stress per G model 212 is configured to provide a stress per G spectrum corresponding to actually encountered flight conditions, which include all regimes/events/maneuvers contributing to the damage experienced during the mission at the fatigue critical locations identified by the OEM or added by the OEM based on operator request. The stress per G spectrum is provided through interpolation achieved using methods such as regression, parameter estimation, machine learning, or soft computing tools (e.g., artificial neural networks). The stress per G spectrum identifies a time domain spectrum of an amount of stress experienced by the airborne vehicle at the identified fatigue critical locations per G of air load contributed by the each of the plurality of regimes/events/maneuvers. The total stress spectrum at the fatigue critical locations of interest are determined through summing the individual stress contributions. The example stress per G model 212 may be derived from OEM stress per G simulation data at OEM chosen fatigue monitoring locations 207.

The example stress per G model 212 may be generated by linearly interpolating OEM stress per G simulation data, for example in the case of a two-parameter model, a direct regression model could be used. When parameters other than speed and altitude, such as fuel weight and/or takeoff weight, are used in the stress per G model, the stress per G model 212 may be generated from OEM stress per G simulation data using machine learning techniques or using soft computing tools (e.g., artificial neural networks) or response surface based meta model techniques using either full factorial designs or partial factorial designs in the data analytic platform for stress interpolation module 210. When parameters other than speed and altitude are likely to influence the stress/G, a response surface model with full factorial design or partial factorial design of experiments can be performed. Using the OEM simulation data as training data sets, a trained model using machine learning techniques, such as a neural net trained model, can be constructed to estimate the stress per g for actually encountered flight condition given the known stress per g for a set of simulated flight conditions.

The example stress calculation module 214 is configured to determine a total air load stress spectrum 216 for the airborne vehicle computed at all fatigue critical locations 207 from the performance of the planned mission by multiplying the time domain spectrum data for flight parameters (e.g., parameter spectrum) with corresponding stress per G values determined for the actual flight condition (e.g., by regression or interpolation) and summing up the air load stress spectrum obtained for the plurality of all regimes/event/maneuvers encountered during the mission to yield a total air load stress spectrum that can be used for fatigue analysis.

The example stress calculation module 214 is configured to combine the usage spectrum from a combination of all maneuvers occurring in each regime/flight events/maneuvers and generating the totality of all such usage spectrum to obtain the total usage spectrum corresponding to the mission at all fatigue critical locations. The usage stress spectrum at a particular fatigue critical location for a component can be calculated for a particular flight segment i and time jth second as Sij(i,j)=Sgnx.Nx(i,j)+Sgny.Ny(i,j)+Sgnx.Nz(i,j)+Sgnp.p(i,j)+Sgnq.q(i,j)+Sgnr.r(i,j)+Sgnp′.p′(i,j)+Sgnq′.q′(i,j)+Sgnr′.r′(i,j)+Sgnp″.p″+Sgnq″.q″(i,j). where:

Sgnx=Stress per g corresponding to longitudinal acceleration Nx at certain Altitude Hn and Mach Number Mn for a particular location;

Sgny=Stress per g corresponding to lateral acceleration Ny at certain Altitude Hn and Mach Number Mn for a particular location;

Sgnz=Stress per g corresponding to Normal acceleration Nz at certain Altitude Hn and Mach Number Mn for a particular location;

Sgnp=Stress per g corresponding to roll p at certain Altitude Hn and Mach Number Mn for a particular location;

Sgnq=Stress per g corresponding to pitch q at certain Altitude Hn and Mach Number Mn for a particular location;

Sgnr=Stress per g corresponding to yaw r at certain Altitude Hn and Mach Number Mn for a particular location;

Sgnp′=Stress per g corresponding to roll rate p′ at certain Altitude Hn and Mach Number Mn for a particular location;

Sgnq′=Stress per g corresponding to yaw rate r′ at certain Altitude Hn and Mach Number Mn for a particular location;

Sgnp″=Stress per g corresponding to roll acceleration p″ at certain Altitude Hn and Mach Number Mn for a particular location; and

Sgnq″=Stress per g corresponding to roll acceleration q″ at certain Altitude Hn and Mach Number Mn for a particular location.

The example damage estimation module 218 is configured to compute a damage index for the airborne vehicle from the air load stress spectrum for a particular location using a cycle counting method. The components of the airframe structure that are to be monitored can be identified and all the fatigue critical locations of interest can be specified for each component. The cumulative damage can be added up at each fatigue critical location to assess the overall damage accumulation at a particular fatigue critical location.

The example remaining useful life module 220 is configured to perform a number of simulations related to estimating the remaining useful life at various fatigue critical locations of the airframe structure, which is provided either by the OEM or added by an operator based on field observations. For computing the remaining useful life 205, the remaining useful life module 220 is configured to predict the most likely future flight profile the helicopter/aircraft will encounter and determine the most likely regimes/events/maneuvers it is likely to perform. The remaining useful life module 220 is configured to assess this from past historical missions performed from across the fleet between the “from” and the “To” destinations, future mission/flight schedule plans, and the design service goal of the aircraft/helicopter. The remaining useful life module 220 is configured to perform several types of what if analysis that can consider various operational issues to improve the likelihood of achieving the maximum utilization of the airborne vehicle from a fatigue usage perspective. The remaining useful life module 220 is configured to use block mission profiles (e.g., profile 1 for certain number of flights, profile 2 for the next set of flights and so on), and mission mixing can also be performed to define future missions. The example remaining useful life module 220 is configured to use past missions accomplished, the damage index expended to date, and likely future mission profile/profiles to estimate the remaining useful life at all fatigue critical locations. The example remaining useful life module 220 is configured to perform a what if analysis to assess the likely impact of changing the mission profile for future missions would have on damage accumulation. The example remaining useful life module 220 is configured to formulate an optimization problem to determine an operating plan, using future mission profiles and machine learning concepts, that can result in lower damage accumulation. The example remaining useful life module 220 is configured to perform fleet analytics on the usage across different fleets to understand the usage patterns or damage accumulation due to different maneuvers under identical regimes and missions and derive insights into operational best practices that can contribute to an optimal usage pattern. The example remaining useful life module 220 is configured to adopt the usage pattern of a specific airborne vehicle to generate a usage-based maintenance plan specific to the specific airborne vehicle thereby facilitating Individual Aircraft Tracking (IAT) by calculating the inspection thresholds and repeat intervals for different fatigue critical locations and developing a strategy to escalate or deescalate inspection plans which is reflected in a CBM advisory report. The example remaining useful life module 220 is configured to derive insights into regimes/maneuvers contributing to higher damage accumulation. The example remaining useful life module 220 is configured to generate a usage-based report for a specific airborne vehicle across different missions at all identified major fatigue critical locations in a format that can be submitted to a certification agency for approval of a modified inspection plan.

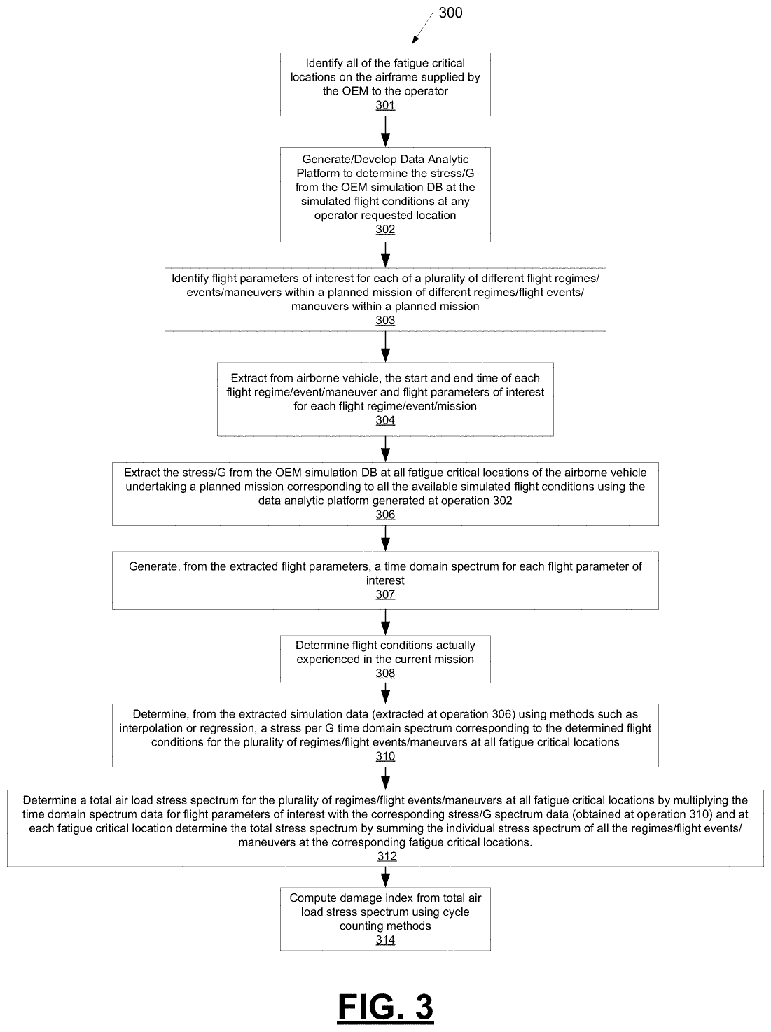

FIG. 3 is process flow chart depicting an example process 300 in a SUMS. The example process 300 includes extracting the stress per G from the simulation data for the actual encountered flight conditions through the use of a data analytic platform which can embed regression, machine learning and neural network algorithms to achieve the desired objectives.

The example process 300 includes identifying all of the fatigue critical locations on the airframe supplied by the OEM to the operator (operation 301) and developing/generating a Data Analytic platform to determine the stress/G from the OEM simulation database using the simulated flight conditions at any operator requested location (operation 302) for the actually encountered flight conditions.

The example process 300 includes identifying flight parameters of interest for each of a plurality of different flight regimes/events/maneuvers within a planned mission (operation 303). Identifying flight parameters of interest may include identifying a plurality of flight phases from the mission profile and identifying the plurality of flight regimes/events/maneuvers from the plurality of flight phases. A flight phase can occur several times per flight because a number of phases are determined by the rate of climb and the position of the flaps. When a flight phase occurs multiple times during a mission, flight load data (derived from flight parameters of interest) can be presented in multiple similar flight phase identified by time stamp. This could provide additional information from fleet analytics point of view. Flight regimes can be determined based on the airspeed, altitude of the airborne vehicle, and potentially other parameters like angle of attack. Different regimes can be identified based on the type of aircraft (commercial or military) or helicopter concerned and the end user objectives for which they are designed. In each regime, a plurality of maneuvers or flight events may occur that contribute to the air load experienced by the airborne vehicle. The air load experienced by the airborne vehicle during a maneuver or flight event can be derived from flight parameters that are determined during the maneuver or flight event. A plurality of flight parameters of interest for each flight regime can be identified based on expected maneuvers to be performed during the flight regime, wherein the flight parameters of interest associated with some of the regimes may be different from flight parameters of interest associated with other regimes, and wherein the flight parameters of interest can be used for capturing an air load spectrum.

The example process 300 includes extracting, from the airborne vehicle, the start and end time of each flight regime/event/maneuver and the flight parameters of interest for each flight regime/event/maneuver (operation 304). Flight phase recognition algorithms, regime recognition algorithms, and/or maneuver and/or flight event identification algorithms may be employed to allow the airborne vehicle to recognize the start and ending of a flight regime, isolate flight events, and allow the airborne vehicle to record starting and ending times for flight regimes and flight events. The flight parameters may be recorded on and extracted from a QAR or FDR.

The example process 300 includes extracting the stress/G from the OEM simulation DB at all fatigue critical locations of the airborne vehicle undertaking a planned mission corresponding to all the available simulated flight conditions using the data analytic platform generated at operation 302 (operation 306). This data can be used to compute the stress/G time domain spectrum corresponding to encountered flight situations.

The example process 300 includes generating, from the extracted flight parameters, a time domain spectrum for each flight parameter of interest (operation 307). The generated time domain spectrum for a flight parameter is generated for a particular flight phase, altitude, and Mach number, which more or less defines the flight conditions actually encountered in the mission for which the stress/G needs to be mapped from the stress/G model available for the simulated flight conditions from the OEM Database.

The example process 300 includes determining flight conditions actually experienced during the mission from the time domain spectrum data (operation 308). The flight conditions may include the airborne vehicle Mach number, airborne vehicle altitude, and other flight parameters of interest that may be needed to establish the state of the aircraft during a particular flight phase. In other examples, the flight conditions could include other data, such as fuel weight or takeoff weight, in addition to Mach number and airborne vehicle altitude.

The example process 300 includes determining, from the extracted simulation data (extracted at operation 306) using methods such as interpolation or regression, a stress per G time domain spectrum corresponding to the determined flight conditions for the plurality of regimes/flight events/maneuvers at all fatigue critical locations (operation 310). The stress per G spectrum identifies a time domain spectrum of an actually encountered amount of stress experienced by the airborne vehicle at a location per G of air load parameters that arises due to aircraft performing various types of regimes/events/maneuvers.

The example process 300 includes determining a total air load stress spectrum for the plurality of regimes/flight events/maneuvers at all fatigue critical locations by multiplying the time domain spectrum data for flight parameters of interest with the corresponding stress/G spectrum data (obtained at operation 310) and at each fatigue critical location determine the total stress spectrum by summing the individual stress spectrum of all the regimes/flight events/maneuvers at the corresponding fatigue critical locations (operation 312). The total air load stress spectrum corresponding to the mission at each fatigue critical location can be determined by summing the individual stress spectrum of all regimes/events/maneuvers.

The example process 300 includes computing a damage index for the airborne vehicle from the total air load stress spectrum using a cycle counting method (operation 314) for the planned mission. The components of the airframe structure that are to be monitored can be identified by the OEM and all the fatigue critical locations of interest can be specified for each component. The cumulative damage can be added up at each fatigue critical location from all planned missions completed to assess the overall damage accumulation at a particular fatigue critical location. Thresholds on the damage index can be set as a part of airline policies.

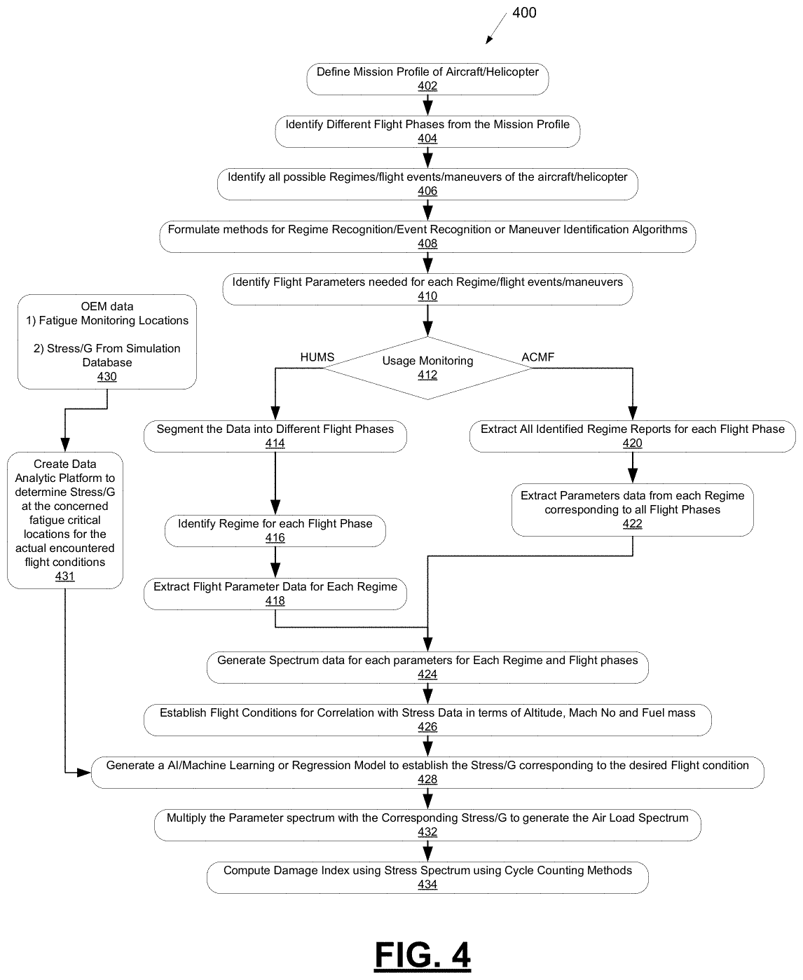

FIG. 4 is process flow chart depicting another example process 400 in a SUMS. The example process 400 includes defining a mission profile of an airborne vehicle (operation 402). Different flight phases are identified from the mission profile (operation 404). Flight regimes flight events/maneuvers of the airborne vehicle are identified from the flight phases (operation 406). Regime recognition or event recognition or maneuver identification algorithms for use on the airborne vehicle are formulated (operation 408). Flight parameters needed for each regime/flight event/maneuver are identified (operation 410). These operations are performed before flight and templates for regime recognition or flight event recognition or maneuver identification are developed.

During flight, usage monitoring occurs and identified flight parameters are recorded (operation 412). Different usage monitoring systems may be employed. After the mission is completed if a HUMS (Health and Usage Monitoring System) was employed, recorded flight parameter data is segmented by flight phases (operation 414). Regimes/events/maneuvers for each flight phase are identified (operation 416). Flight parameters data for each regime/flight events/maneuvers are extracted (operation 418). If an ACMF (Aircraft Condition Monitoring Function) was employed, all identified regime/flight events/maneuvers reports for each flight phase are extracted (operation 420). Parameter data for each regime/flight events/maneuvers corresponding to all flight phases are extracted (operation 422).

After extracting parameter data, time domain spectrum data is generated for each parameter for each regime/flight events/maneuvers and flight phase (operation 424). The flight conditions for correlation with stress data in terms of altitude, Mach number, and fuel mass and other relevant parameters are established (operation 426). A model, (e.g., an AI, machine learning, or regression model) is generated to establish the stress per G corresponding to the desired flight condition (operation 428). The model is generated based on a data analytic platform using OEM simulation data (operation 430) to map the stress/G values from the simulated conditions to the actual encountered flight conditions. The OEM data includes fatigue monitoring locations and stress per G data from an OEM simulation database for a set of simulated flight conditions. The Data Analytic Platform is created to determine stress/G at the concerned fatigue critical locations for the actual encountered flight conditions (operation 431). The parameters spectrum is multiplied with the corresponding stress per G for those parameters to generate the air load stress spectrum (operation 432) and then summing up individual air load stress spectrum to yield a total stress spectrum for that particular fatigue critical location. A damage index is computed using the total air load stress spectrum using cycle counting methods (operation 434) for that mission from where we can get the cumulative damage index by summing up the damage index for all completed missions.

Described are apparatus, systems, techniques, methods, and articles for monitoring air load and stress experienced by an airborne vehicle. The described apparatus, systems, techniques, methods, and articles may allow for real time assessment of fatigue life based on the operational usage of an airborne vehicle (e.g., helicopter/aircraft) and provide valuable insights for scheduling the maintenance of the airborne vehicle. The described apparatus, systems, techniques, methods, and articles may enable an operator to track the usage of each airborne vehicle fleet and develop an individual inspection plan for the fleet after performing fleet analytics. The described apparatus, systems, techniques, methods, and articles may allow for determining a new inspection interval dynamically based on actual usage data by calculating inspection thresholds and repeat intervals, life consumed and remaining useful life periodically as desired by an airframe engineer. The described apparatus, systems, techniques, methods, and articles may allow for the escalation or de-escalation of an inspection schedule based on actual health and usage information. The described apparatus, systems, techniques, methods, and articles may assist in generating appropriate certification reports regarding the health state of a component to submit a request to regulatory authorities to extend the life of a component. The described apparatus, systems, techniques, methods, and articles may be used in evaluating a damage fatigue index, fatigue life consumed, and/or remaining useful life at critical fatigue locations. The described apparatus, systems, techniques, methods, and articles may be used for fleet analytics for fatigue monitoring.

In one embodiment, a method for monitoring service load on airborne vehicle components is provided. The method comprises: extracting, from an airborne vehicle after completing a planned mission, the start and end time of each of a plurality of flight regimes/events/maneuvers and flight parameters of interest for each of the plurality of regimes/events/maneuvers; generating, for each regime, a time domain spectrum of the stress spectrum for each regime/events/maneuvers actually encountered in the mission from the extracted flight parameters of interest; determining flight conditions experienced during the planned mission from the time domain spectrum data for each flight parameter of interest; determining a stress per G (per unit load) spectrum corresponding to actually experienced flight conditions, wherein the stress per G spectrum identifies an amount of stress experienced by the airborne vehicle at identified fatigue critical locations per G of air load caused by the regimes/events/maneuvers experienced in the planned mission at the fatigue critical location of interest; and determining a total air load stress spectrum for the airborne vehicle from the performance of the planned mission by multiplying the time domain spectrum data for each flight parameter of interest with corresponding stress per G spectrum data determined for the experienced flight conditions (e.g., at all fatigue critical locations provided by the OEM through interpolation achieved using any of the methods like regression, parameter interpolation and/or using machine learning/soft computing tools like neural networks) and summing up the air load stress spectrum obtained for all regimes/event/maneuvers encountered during the mission.

These aspects and other embodiments may include one or more of the following features. The method may further comprise computing a damage index for the airborne vehicle from the total air load stress spectrum using a cycle counting method for each identified fatigue critical location for the planned mission. The method may further comprise computing the cumulative damage at each fatigue critical location by summing up the damage index from all completed planned missions completed to assess the overall damage accumulation at a particular fatigue critical location. The method may further comprise: identifying, based on a mission profile for the planned mission, the flight parameters of interest for each of the plurality of different regimes/events/maneuvers within the planned mission; and instructing the airborne vehicle to record, during performance by the airborne vehicle of the planned mission, the start and end time of each of the plurality of regimes/events/maneuvers and the flight parameters of interest for each of the plurality of regimes/events/maneuvers. The identifying the flight parameters of interest may comprise: identifying the plurality of regimes/events/maneuvers from the mission profile, wherein the identifying includes identifying a plurality of flight phases from the mission profile and identifying the plurality of regimes/events/maneuvers from the plurality of flight phases; and identifying a plurality of flight parameters of interest for each flight regime based on expected flight events and maneuvers to be performed during the flight regime, wherein the flight parameters of interest associated with some of the regimes/events/maneuvers are different from flight parameters of interest associated with other regimes/events/maneuvers, wherein the flight parameters of interest can be used for capturing the air load spectrum at every fatigue critical location during a planned mission. The flight parameters of interest may be selected from a set of potential flight parameters that includes Normal Acceleration, Lateral Acceleration, Longitudinal Acceleration, Roll, Pitch, Yaw, Roll rate, Pitch Rate, Yaw Rate, Roll Acceleration, Pitch Acceleration, Altitude, Temperature, Pressure, Angle of Attack, Side Slip Angle, Mass of Fuel, Mach Number, Calibrated Air Speed, and other flight parameters that may influence the air load at different locations of the aircraft. The flight regimes may be determined based on airspeed and altitude of the airborne vehicle. The flight conditions may comprise the airspeed, Mach number, altitude, flight phase of the airborne vehicle, and other flight parameters of interests that may be needed to establish the state of the aircraft during a particular flight phase. Determining a stress per G spectrum may comprise determining the stress per G spectrum from a stress per G model derived using OEM stress per G simulation data. The stress per G model may be generated by linearly interpolating OEM stress per G simulation data, which includes stress per G values for a set of simulated flight conditions which may or may not correspond to the exactly encountered flight condition during a mission. The stress per G model for actual flight conditions experienced by the airborne vehicle may be generated, using machine learning techniques or soft computing tools, by mapping OEM stress per G simulation data corresponding to simulated flight conditions to stress per G spectrum data for experienced flight conditions. The method may further comprise generating the total usage spectrum corresponding to the planned mission at all fatigue critical locations by combining the usage spectrum from a combination of all maneuvers and flight events occurring in each regime. The method may further comprise generating the total usage spectrum corresponding to the planned mission at all fatigue critical locations by combining the usage spectrum from a combination of all maneuvers and flight events occurring in each regime. The method may further comprise estimating the remaining useful life of a component at a fatigue critical location based on the most likely flight profile to be experienced at the fatigue critical location on future flights. Estimating the remaining useful life may comprise deriving a likely mission profile for the remaining missions to be performed based on past historical missions performed using machine learning concepts. The method may further comprise performing a what if analysis to assess the likely impact that changing the mission profile for future missions would have on damage accumulation.

In another embodiment, a structural usage monitoring system is provided. The structural usage monitoring system comprises one or more processors configured by programming instructions in non-transient computer readable media. The structural usage monitoring system is configured to: identify, based on a mission profile for a planned mission for an airborne vehicle, flight parameters of interest for each of a plurality of different flight regimes/events/maneuvers within a planned mission; instruct the airborne vehicle to record, during performance by the airborne vehicle of the planned mission, the start and end time of each of the plurality of flight regimes, flight events, and maneuvers (regimes/events/maneuvers) and the flight parameters of interest for each of the plurality of flight regimes/events/maneuvers; extract, from the airborne vehicle after completing the planned mission, the start and end time of each of the plurality of regimes/events/maneuvers and the flight parameters of interest for each of the plurality of flight regimes/events/maneuvers; and generate for each regime, from the recorded aircraft parameters, a time domain spectrum of the stress spectrum for each regime/events/maneuvers actually encountered in the mission from the extracted flight parameters of interest. The structural usage monitoring system is further configured to: determine flight conditions experienced during the planned mission from the time domain spectrum data; determine a stress per G (per unit load) spectrum corresponding to the experienced flight conditions, wherein the stress per G spectrum identifies an amount of stress experienced by the airborne vehicle at fatigue critical locations per G of air load caused by the regimes/events/maneuvers experienced in the planned mission at the fatigue critical location of interest; determine a total air load stress spectrum for the airborne vehicle from the performance of the planned mission by multiplying the time domain spectrum data for each flight parameter of interest with corresponding stress per G spectrum data determined for the experienced flight conditions and summing up the air load stress spectrum obtained for all regimes/event/maneuvers encountered during the mission; and compute a damage index for the airborne vehicle from the air load stress spectrum using a cycle counting method for each identified fatigue critical location for the planned mission.

These aspects and other embodiments may include one or more of the following features. The structural usage monitoring system may be further configured to: identify the plurality of flight regimes from the mission profile by identifying a plurality of flight phases from the mission profile and identifying the plurality of flight regimes from the plurality of flight phases; and identify a plurality of flight parameters of interest for each flight regime based on expected maneuvers to be performed during the flight regime, wherein the flight parameters of interest associated with some of the regimes are different from flight parameters of interest associated with other regimes, wherein the flight parameters of interest can be used for capturing the air load spectrum. The structural usage monitoring system may be further configured to estimate the remaining useful life of a component at a fatigue critical location based on the most likely flight profile to be experienced at the fatigue critical location on future flights. The structural usage monitoring system may be further configured to estimate the remaining useful life by deriving a likely mission profile for the remaining missions to be performed based on past historical missions performed using machine learning concepts. The structural usage monitoring system may be further configured to perform a what if analysis to assess the likely impact that changing the mission profile for future missions would have on damage accumulation. The structural usage monitoring system may be further configured to determine future mission profiles that result in lower damage accumulation. The structural usage monitoring system may be further configured to generate a usage-based maintenance plan specific to a specific airborne vehicle based on the usage pattern of the specific airborne vehicle thereby facilitating Individual Aircraft Tracking (IAT) by calculating the inspection thresholds and repeat intervals for different fatigue critical locations and developing a strategy to escalate or deescalate inspection plans which is reflected in a CBM advisory report.

In another embodiment, a remaining useful life module in a structural usage monitoring system is provided. The structural usage monitoring system comprises one or more processors configured by programming instructions on non-transient computer readable media. The structural usage monitoring system is configured to extract flight parameters of interest from an airborne vehicle for a plurality of flight regimes/events/maneuvers from a mission and determine a total air load stress spectrum for the airborne vehicle using the extracted flight parameters and a stress per G (per unit load) spectrum wherein the stress per G spectrum identifies an amount of stress experienced by the airborne vehicle at fatigue critical locations per G of air load caused by the regimes/events/maneuvers at the fatigue critical locations. The remaining useful life module is configured to: estimate the remaining useful life of a component at a fatigue critical location based on the most likely flight profile to be experienced at the fatigue critical location on future flights; estimate the remaining useful life by deriving a likely mission profile for the remaining missions to be performed based on past missions performed; perform a what if analysis to assess the likely impact that changing the mission profile for future missions would have on damage accumulation; and generate a usage-based maintenance plan specific to a specific airborne vehicle based on the usage pattern of the specific airborne vehicle thereby facilitating Individual Aircraft Tracking (IAT) by calculating the inspection thresholds and repeat intervals for different fatigue critical locations and developing a strategy to escalate or deescalate inspection plans which is reflected in a CBM advisory report.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention if such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for monitoring service load on airborne vehicle components, the method comprising:
extracting, from an airborne vehicle after completing a planned mission, the start and end time of each of a plurality of flight regimes, flight events, and maneuvers (regimes/events/maneuvers) and flight parameters of interest for each of the plurality of regimes/events/maneuvers;
generating, for each regime, a time domain spectrum of the stress spectrum for each regime/events/maneuvers actually encountered in the mission from the extracted flight parameters of interest;
determining flight conditions experienced during the planned mission from the time domain spectrum data for each flight parameter of interest;
determining a stress per G (per unit load) spectrum corresponding to the actually experienced flight conditions, wherein the stress per G spectrum identifies an amount of stress experienced by the airborne vehicle at identified fatigue critical locations per G of air load caused by the regimes/events/maneuvers experienced in the planned mission at the fatigue critical location of interest; and
determining a total air load stress spectrum for the airborne vehicle from the performance of the planned mission by multiplying the time domain spectrum data for each flight parameter of interest with corresponding stress per G spectrum data determined for the experienced flight conditions and summing up the air load stress spectrum obtained for all regimes/event/maneuvers encountered during the mission.

2. The method of claim 1, further comprising computing a damage index for the airborne vehicle from the total air load stress spectrum using a cycle counting method for each identified fatigue critical location for the planned mission.

3. The method of claim 2, further comprising computing the cumulative damage at each fatigue critical location by summing up the damage index from all completed planned missions completed to assess the overall damage accumulation at a particular fatigue critical location.

4. The method of claim 1, further comprising:
identifying, based on a mission profile for the planned mission, the flight parameters of interest for each of the plurality of different regimes/events/maneuvers within the planned mission; and
instructing the airborne vehicle to record, during performance by the airborne vehicle of the planned mission, the start and end time of each of the plurality of regimes/events/maneuvers and the flight parameters of interest for each of the plurality of regimes/events/maneuvers.

5. The method of claim 4, wherein the identifying the flight parameters of interest comprises:
identifying the plurality of regimes/events/maneuvers from the mission profile, wherein the identifying includes identifying a plurality of flight phases from the mission profile and identifying the plurality of regimes/events/maneuvers from the plurality of flight phases; and
identifying a plurality of flight parameters of interest for each flight regime based on expected flight events and maneuvers to be performed during the flight regime, wherein the flight parameters of interest associated with some of the regimes/events/maneuvers are different from flight parameters of interest associated with other regimes/events/maneuvers, wherein the flight parameters of interest can be used for capturing the total air load spectrum experienced at every fatigue critical location during a planned mission.

6. The method of claim 1, wherein the flight parameters of interest are selected from a set of potential flight parameters that includes Normal Acceleration, Lateral Acceleration, Longitudinal Acceleration, Roll, Pitch, Yaw, Roll rate, Pitch Rate, Yaw Rate, Roll Acceleration, Pitch Acceleration, Altitude, Temperature, Pressure, Angle of Attack, Side Slip Angle, Mass of Fuel, Mach Number, Calibrated Air Speed, and other flight parameters that influence the air load at different locations of the aircraft.

7. The method of claim 1, wherein the flight regimes are determined based on airspeed and altitude of the airborne vehicle.

8. The method of claim 1, wherein the flight conditions comprise the airspeed, Mach number, altitude, flight phase of the airborne vehicle, and other flight parameters of interests that are needed to establish the state of the aircraft during a particular flight phase.

9. The method of claim 1, wherein the determining a stress per G spectrum comprises determining the stress per G spectrum from a stress per G model derived using OEM (original equipment manufacturer) stress per G simulation data.

10. The method of claim 9, wherein the stress per G model for actual flight conditions experienced by the airborne vehicle is generated by linearly interpolating OEM stress per G simulation data, which includes stress per G values for a set of simulated flight conditions which may or may not correspond to the exactly encountered flight condition during a mission.

11. The method of claim 9, wherein the stress per G model for actual flight conditions experienced by the airborne vehicle is generated, using machine learning techniques or soft computing tools, by mapping OEM stress per G simulation data corresponding to simulated flight conditions to stress per G spectrum data for experienced flight conditions.

12. The method of claim 1, further comprising generating the total usage spectrum corresponding to the planned mission at all fatigue critical locations by combining the usage spectrum from a combination of all maneuvers and flight events occurring in each regime.

13. The method of claim 1, further comprising estimating the remaining useful life of a component at a fatigue critical location based on the most likely flight profile to be experienced at the fatigue critical location on future flights.

14. The method of claim 13 wherein estimating the remaining useful life comprises deriving a likely mission profile for the remaining missions to be performed based on past historical missions performed using machine learning concepts.

15. The method of claim 1, further comprising performing a what if analysis to assess the likely impact that changing the mission profile for future missions would have on damage accumulation.

16. A structural usage monitoring system comprising one or more processors configured by programming instructions in non-transient computer readable media, the structural usage monitoring system configured to:
identify, based on a mission profile for a planned mission for an airborne vehicle, flight parameters of interest for each of a plurality of different flight regimes within a planned mission;
instruct the airborne vehicle to record, during performance by the airborne vehicle of the planned mission, the start and end time of each of the plurality of flight regimes, flight events, and maneuvers (regimes/events/maneuvers) and the flight parameters of interest for each of the plurality of regimes/events/maneuvers;
extract, from the airborne vehicle after completing the planned mission, the start and end time of each of the plurality of regimes/events/maneuvers and the flight parameters of interest for each of the plurality of regimes/events/maneuvers;
generate for each regime, from the recorded aircraft parameters, a time domain spectrum of the stress spectrum for each regime/events/maneuvers actually encountered in the mission from the extracted flight parameters of interest;
determine flight conditions experienced during the planned mission from the time domain spectrum data;
determine a stress per G (per unit load) spectrum corresponding to the experienced flight conditions, wherein the stress per G spectrum identifies an amount of stress experienced by the airborne vehicle at fatigue critical locations per G of air load caused by the regimes/events/maneuvers experienced in the planned mission at the fatigue critical location of interest;
determine a total air load stress spectrum for the airborne vehicle from the performance of the planned mission by multiplying the time domain spectrum data for each flight parameter of interest with corresponding stress per G spectrum data determined for the experienced flight conditions and summing up the air load stress spectrum obtained for all regimes/event/maneuvers encountered during the mission; and
compute a damage index for the airborne vehicle from the total air load stress spectrum using a cycle counting method for each identified fatigue critical location for the planned mission.

17. The structural usage monitoring system of claim 16, further configured to perform a what if analysis to assess the likely impact that changing the mission profile for future missions would have on damage accumulation.

18. The structural usage monitoring system of claim 16, further configured to determine future mission profiles that result in lower damage accumulation.

19. The structural usage monitoring system of claim 16, further configured to generate a usage-based maintenance plan specific to a specific airborne vehicle based on the usage pattern of the specific airborne vehicle thereby facilitating Individual Aircraft Tracking (IAT) by calculating the inspection thresholds and repeat intervals for different fatigue critical locations and developing a strategy to escalate or deescalate inspection plans which is reflected in a CBM advisory report.

20. A remaining useful life module in a structural usage monitoring system, the structural usage monitoring system comprising one or more processors configured by programming instructions on non-transient computer readable media, the structural usage monitoring system configured to extract flight parameters of interest from an airborne vehicle for a plurality of flight regimes, flight events, and maneuvers (regimes/events/maneuvers) from a mission and determine a total air load stress spectrum for the airborne vehicle using the extracted flight parameters and a stress per G (per unit load) spectrum wherein the stress per G spectrum identifies an amount of stress experienced by the airborne vehicle at fatigue critical locations per G of air load caused by the regimes/events/maneuvers at the fatigue critical locations, the remaining useful life module configured to:
estimate the remaining useful life of a component at a fatigue critical location based on the most likely flight profile to be experienced at the fatigue critical location on future flights;
estimate the remaining useful life by deriving a likely mission profile for the remaining missions to be performed based on past missions performed;
perform a what if analysis to assess the likely impact that changing the mission profile for future missions would have on damage accumulation; and
generate a usage-based maintenance plan specific to a specific airborne vehicle based on the usage pattern of the specific airborne vehicle thereby facilitating Individual Aircraft Tracking (IAT) by calculating the inspection thresholds and repeat intervals for different fatigue critical locations and developing a strategy to escalate or deescalate inspection plans which is reflected in a CBM advisory report.
